(19) United States
(12) Patent Application Publication
(10) Pub. No.: US 2017/0264819 A1
(43) Pub. Date: Sep. 14, 2017

(54) IMAGING DEVICE

(71) Applicant: Panasonic Intellectual Property Management Co., Ltd., Osaka (JP)

(72) Inventor: MITSUYOSHI OKAMOTO, Osaka (JP)

(21) Appl. No.: 15/447,256

(22) Filed: Mar. 2, 2017

(30) Foreign Application Priority Data
Mar. 9, 2016 (JP) 2016-046196
Dec. 28, 2016 (JP) 2016-254946

(51) Int. Cl. H04N 5/232; H04N 5/77

(52) U.S. Cl. CPC H04N 5/23216; H04N 5/23212; H04N 5/77; H04N 5/23293

(57) ABSTRACT

The imaging device includes an optical system including a focus lens, an imaging unit that images a subject image input via the optical system and generates an image signal, an image processor that executes a predetermined process on the image signal and generates image data, an operation unit that accepts a user operation, and a controller that controls the image processor.

### BACKGROUND

1. Technical Field

The present disclosure relates to an imaging device that can record an image focused on an image region specified by a user.

2. Description of the Related Art

PTL 1 discloses an imaging device that generates a still image desired by a user from a plurality of frame images forming recorded moving image data. Before recording a moving image, the imaging device in PTL 1 obtains a focus position for each image divided region while moving a focus lens in a movable range of the focus lens. Thereafter, the imaging device records the moving image while moving the focus lens in the same range. The imaging device extracts one image specified by a user from frame images forming moving image data so as to generate a still image. As a result, the user can obtain an image photographed at a decisive moment without being conscious of a right moment for a good picture.

### CITATION LIST

### Patent Literature

PTL 1: Japanese Patent No. 5866674

### SUMMARY

The present disclosure provides an imaging device that generates a still image from moving image data, in which a processing time for shooting can be shortened.

One aspect of the present disclosure provides an imaging device. The imaging device includes an optical system including a focus lens, an imaging unit that images a subject image input via the optical system and generates an image signal, an image processor that executes a predetermined process on the image signal and generates image data, an operation unit that accepts a user operation, and a controller that controls the image processor. The controller executes a search process for obtaining a focus distance in each of a plurality of predetermined regions indicated by the image data while moving the focus lens in a predetermined drive range. After the search process, the controller records a moving image while moving the focus lens, and extracts, as a still image, a frame image focused on a region specified by a user via the operation unit from a plurality of frame images forming recorded moving image data. Before the search process, the controller sets the predetermined drive range based on a range specified by the user via the operation unit.

The imaging device of the present disclosure sets the drive range of the focus lens for the search process or the like based on the range specified by the user via the operation unit. As a result, the drive of the focus lens in an entire range is reduced, and thus a processing time for the search process can be shortened.

### BRIEF DESCRIPTION OF THE DRAWINGS

FIG. 1 is a block diagram illustrating a configuration of a digital camera according to a first exemplary embodiment;

FIG. 2 is a rear view illustrating the digital camera according to the first exemplary embodiment;

FIG. 3A is a diagram for describing a movement of a focus lens in a focus selecting function of the digital camera according to the first exemplary embodiment;

FIG. 3B is a diagram for describing specification of a focus region by a user on an image of the digital camera according to the first exemplary embodiment;

FIG. 3C is a diagram for describing an image focused on a subject (region) specified by the user on the image of the digital camera according to the first exemplary embodiment;

FIG. 4 is a diagram for describing cutting out of a still image from moving image data in the focus selecting function of the digital camera according to the first exemplary embodiment;

FIG. 5A is a diagram for describing an AF region set in the image region of the digital camera according to the first exemplary embodiment;

FIG. 5B is a diagram for describing a change in a contrast value in one AF region;

FIG. 6A is a diagram illustrating an example of a focus information table in the digital camera according to the first exemplary embodiment;

FIG. 6B is a diagram for describing a drive range of the focus lens during a focus search in the digital camera according to the first exemplary embodiment;

FIG. 6C is a diagram for describing a drive range of the focus lens during recording of a moving image in the digital camera according to the first exemplary embodiment;

FIG. 7 is a flowchart illustrating a focus selecting operation in the digital camera according to the first exemplary embodiment;

FIG. 8 is a diagram illustrating an example of a screen to be displayed just after recording of moving image data (a focus region specifying screen) in the digital camera according to the first exemplary embodiment;

FIG. 9A is a diagram for describing an operation for specifying a focus region desired by a user in the digital camera according to the first exemplary embodiment;

FIG. 9B is a diagram for describing the focus region specified by the user in the digital camera according to the first exemplary embodiment;

FIG. 9C is a diagram for describing an image focused on a subject specified by the user in the digital camera according to the first exemplary embodiment;

FIG. 10A is a diagram for describing setting of the drive range of the focus lens based on a touch operation by the user in the digital camera according to the first exemplary embodiment;

FIG. 10B is a diagram for describing a partial region of a subject in FIG. 10A;

FIG. 10C is a diagram for describing the drive range of the focus lens in the digital camera according to the first exemplary embodiment;

FIG. 11 is a flowchart illustrating a process for setting the drive range of the focus lens in the digital camera according to the first exemplary embodiment; and

FIG. 12 is a flowchart illustrating the process for setting the drive range of the focus lens in the digital camera according to a second exemplary embodiment.

### DETAILED DESCRIPTION

Exemplary embodiments are described below suitably with reference to the drawings. Description that is more detailed than necessary is occasionally omitted. For example, detailed description about already well-known matters and overlapped description about substantially the same configuration are occasionally omitted. This is to avoid the following description from being unnecessarily redundant and to have a person skilled in the art easily understand the present disclosure. The inventors provide the accompanying drawings and the following description in order to have the skilled in the art fully understand the present disclosure, and the drawings and the description are not intended to limit a subject matter described in the claims.

An imaging device according to exemplary embodiments of the present disclosure is described below with reference to the drawings.

### First Exemplary Embodiment

### 1. Configuration

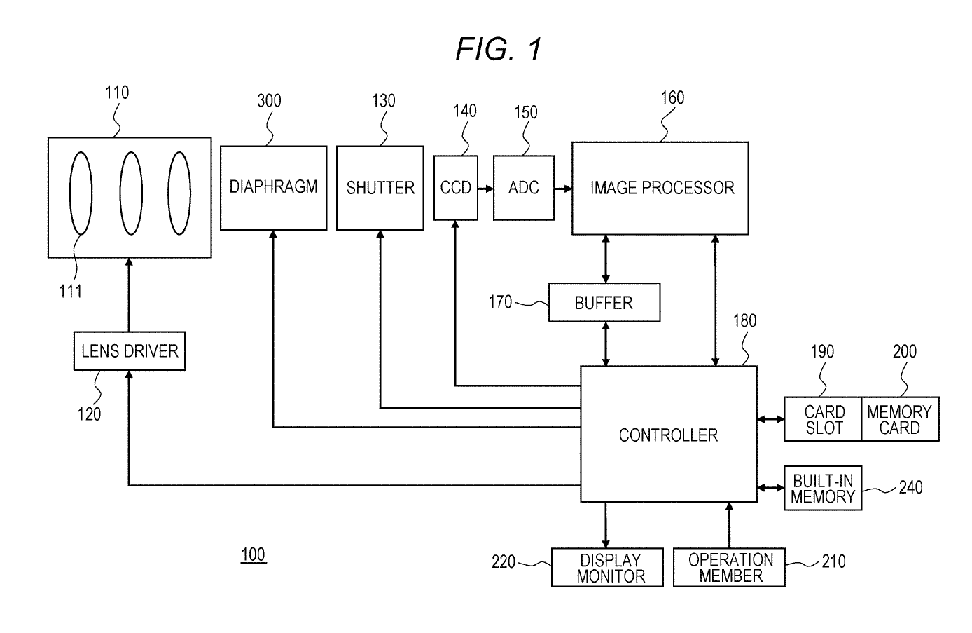

An electrical configuration of a digital camera according to a first exemplary embodiment is described with reference to FIG. 1. FIG. 1 is a block diagram illustrating a configuration of digital camera 100 according to the first exemplary embodiment. Digital camera 100 is an imaging device that images a subject image formed by optical system 110 including one lens or a plurality of lenses using CCD (Charge Coupled Device) 140. Image data generated by CCD 140 is subjected to various processes by image processor 160, and is stored in memory card 200. The configuration of digital camera 100 is described in detail below.

Optical system 110 includes a zoom lens and focus lens 111. When the zoom lens is moved along an optical axis, a subject image can be enlarged or reduced. Further, when focus lens 111 is moved along the optical axis, focus (a focal state) of the subject image can be adjusted.

Lens driver 120 drives various lenses included in optical system 110. Lens driver 120 includes, for example, a zoom motor that drives the zoom lens, and a focus motor that drives focus lens 111.

Diaphragm unit 300 automatically adjusts the size of an opening depending on setting by the user to adjust the quantity of light transmitting through the opening.

Shutter unit 130 shields light to transmit toward CCD 140. Shutter unit 130 as well as optical system 110 and diaphragm unit 300 configure an optical system part that controls optical information representing a subject image. Optical system 110 and diaphragm unit 300 are housed in a lens barrel (not shown).

CCD 140 images a subject image formed by optical system 110 and generates image data. CCD 140 includes a color filter, a light receiving element, and an auto gain controller (AGC). The light receiving element converts an optical signal condensed by optical system 110 into an electric signal, and generates image information. The AGC amplifies the electric signal output from the light receiving element.

ADC (analog to digital converter: analog-digital converter) 150 converts analog image data generated by CCD 140 into digital image data.

Image processor 160 executes various processes on the digital image data generated by CCD 140 and converted by ADC 150 under control of controller 180. Image processor 160 generates image data to be displayed on display monitor 220, and generates image data to be stored in memory card 200. For example, image processor 160 executes various processes, such as gamma correction, white balance correction, and flaw correction, on the image data generated by CCD 140. Image processor 160 compresses the image data generated by CCD 140 according to a compression format being based on an 11.264 standard or an MPEG2 (Moving Picture Experts Group 2) standard. Image processor 160 can generate image data of a moving image (called also 4K moving image data) with about a pixel number of 4000×2000 based on the image data generated by CCD 140. Image processor 160 can execute various processes, described later, on the generated 4K moving image data.

Controller 180 is a controller that entirely controls digital camera 100. Controller 180 can be provided by a semiconductor element or the like. Controller 180 may be provided only by hardware or by combining hardware and software. Image processor 160 and controller 180 can be provided by a microcomputer, CPU (Central Processing Unit), MPU (Micro-processing Unit), DSP (Digital Signal Processor), ASIC (Application Specific Integrated Circuit), or FPGA (Field-programmable Gate Array).

Buffer 170 functions as a work memory of image processor 160 and controller 180. Buffer 170 can be provided by, for example, DRAM (Dynamic Random Access Memory), or a ferroelectric memory.

Card slot 190 is a slot for attaching memory card 200 to digital camera 100. Card slot 190 can mechanically and electrically connect memory card 200 and digital camera 100.

Memory card 200 contains a flash memory or a ferroelectric memory, and can store data such as an image file generated by image processor 160.

Built-in memory 240 is configured by a flash memory or a ferroelectric memory. Built-in memory 240 stores a control program, data, and the like for controlling entire digital camera 100.

Operation member 210 is a general name of user interfaces that accept operations from the user. Operation member 210 includes buttons, a lever, a dial, a touch panel, and a switch that accept operations from the user. Operation member 210 includes a focus ring provided on an outer periphery of the lens barrel. The focus ring is a member that is rotated by the user to move focus lens 111.

Display monitor 220 can display an image represented by the image data generated by CCD 140 (a through-the-lens image) or image data read from memory card 200. Display monitor 220 can display also various menu screens and the like for performing various settings of digital camera 100. Display monitor 220 is configured by a liquid crystal display device or an organic EL (Electroluminescence) display device.

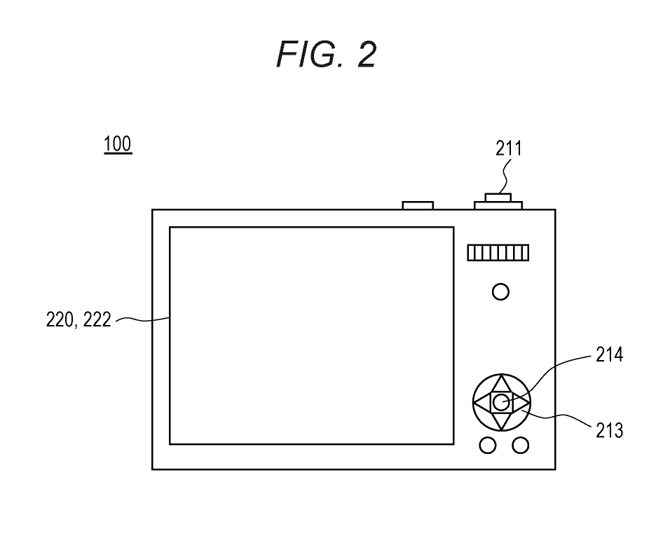

FIG. 2 is a rear view illustrating digital camera 100 according to the first exemplary embodiment. In FIG. 2, as an example of operation member 210, release button 211, selection button 213, decision button 214, and touch panel 222 are shown. When accepting an operation from a user, operation member 210 transmits various instruction signals to controller 180. Release button 211 is a two-step depression button. When the user half-presses release button 211, controller 180 makes autofocus control (AF control) and automatic exposure control (AE control). When the user full-presses release button 211, controller 180 records the image data captured at a timing of the depression operation as a recording image into memory card 200 or the like.

Selection button 213 is a depression button provided in up, down, right and left directions. The user presses selection button 213 in any one of the up, down, right, and left directions so as to be capable of moving a cursor or selecting various condition items displayed on display monitor 220.

Decision button 214 is a depression button. When digital camera 100 is in a photography mode or a reproduction mode and the user presses decision button 214, controller 180 displays a menu screen on display monitor 220. The menu screen is a screen for setting various conditions of photography/reproduction. When decision button 214 is pressed while the setting items of various conditions are displayed, controller 180 defines a selected item.

Touch panel 222 is disposed so as to be overlaid on a display screen of display monitor 220, and detects a touch operation on the display screen to be performed by a finger of the user. As a result, the user can perform an operation for specifying a region on an image displayed on display monitor 220.

### 2. Operation

### 2.1 Focus Selecting Function

Digital camera 100 according to this exemplary embodiment has a focus selecting function for recording one frame selected by the user from a plurality of frame images photographed simultaneously in different focus positions (focus lens positions). This function enables the user to select the focus position after photography. The focus selecting function is set ON (activated)/OFF (deactivated) on a menu by the user.

In the focus selecting function, one frame is selected by the user from a plurality of frames configuring a moving image taken while the focus position is being changed so as to be recorded. In the focus selecting function, a 4K moving image with high-resolution of about the number of pixels 4000×2000 is recorded. One frame image is cut out from the 4K moving image based on specification by the user, so that a still image is obtained. Since the still image obtained in such a manner is cut out from the 4K moving image, the still image has high image quality.

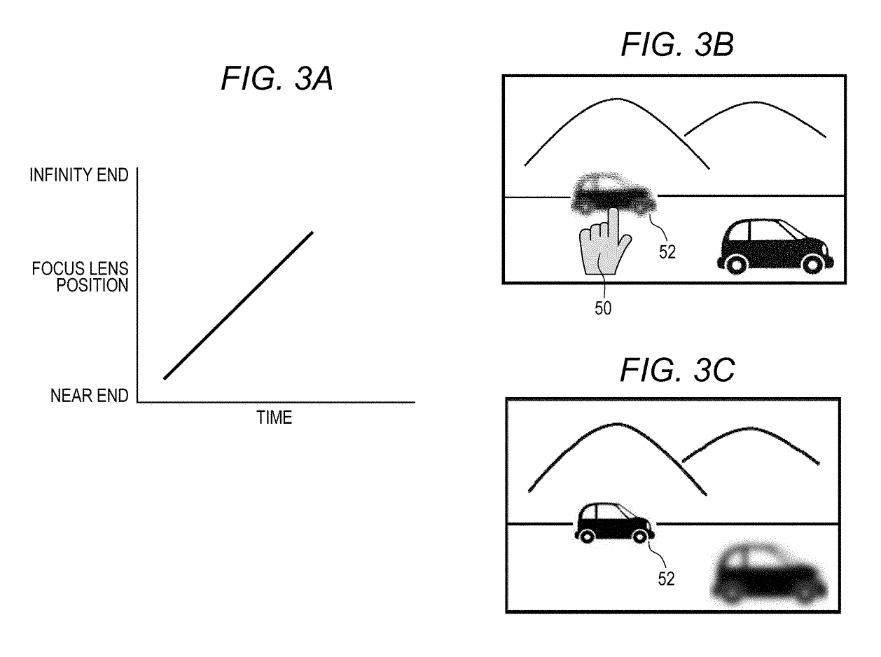

FIG. 3A is a diagram for describing the movement of a focus lens in the focus selecting function of digital camera 100 according to the first exemplary embodiment. FIG. 3B is a diagram for describing specification of the focus region performed by the user on an image of digital camera 100 according to the first exemplary embodiment. FIG. 3C is a diagram for describing an image focused on subject (region) 52 specified by the user on the image of digital camera 100 according to the first exemplary embodiment.

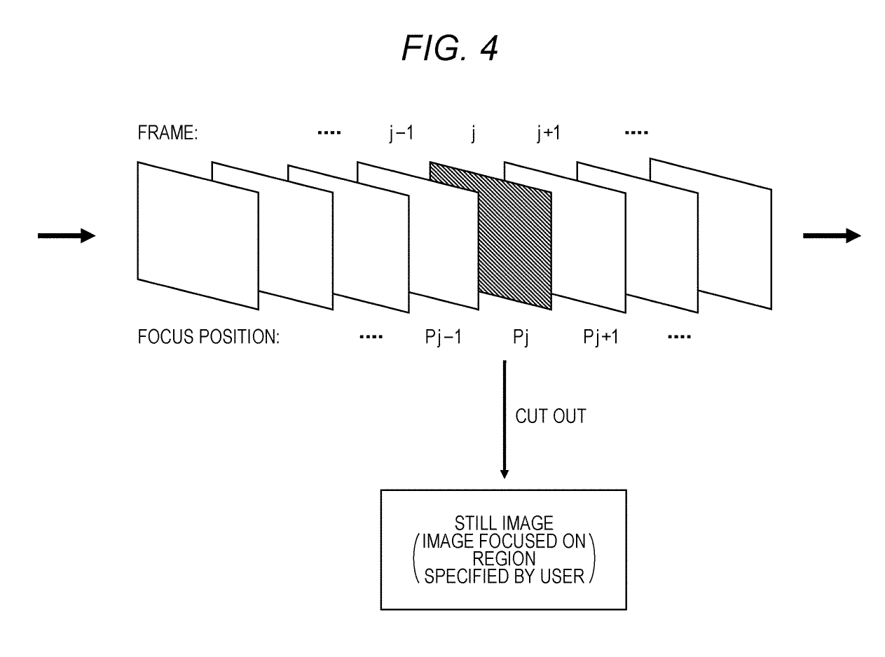

Concretely, in the focus selecting function, as shown in FIG. 3A, while focus lens 111 is being moved toward a near close end to an infinity end (or vice versa), namely, the focus position is being changed, a moving image is taken. Thereafter, as shown in FIG. 3B, user 50 performs the touch operation to specify subject 52 to be focused (namely, a region) on the photographed image. FIG. 4 is a diagram for describing cutting out of a still image from moving image data in the focus selecting function of the digital camera according to the first exemplary embodiment. Digital camera 100, as shown in FIG. 4, selects one frame image focused on the region specified by the user from a plurality of frame images configuring the moving image, and cuts out to record the one image as a still image. As a result, a high-quality still image focused on subject (region) 52 specified by the user can be obtained as shown in FIG. 3C.

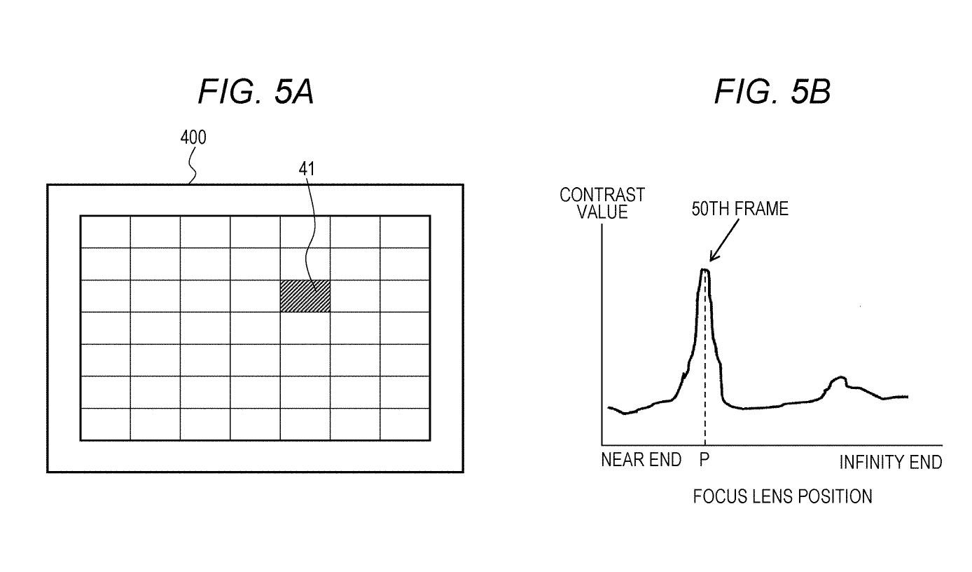

FIG. 5A is a diagram for describing an AF region set on the image region of the digital camera according to the first exemplary embodiment. FIG. 5B is a diagram for describing a change in a contrast value on one AF region.

In digital camera 100 according to this exemplary embodiment, a plurality of (49) AF regions shown in FIG. 5A is set on image region 400 in relation to the autofocus operation. A frame focused on this region (hereinafter, “focused frame”) is obtained from the plurality of frames configuring the moving image for each AF region, and information about the obtained focused frame is recorded in a focus information table. In a focus selecting operation, digital camera 100 performs a focus search operation before recording (taking) a moving image, and generates partial information in focus information the focus information table. Residual information in the focus information table is generated in a moving image recording operation after the focus search operation.

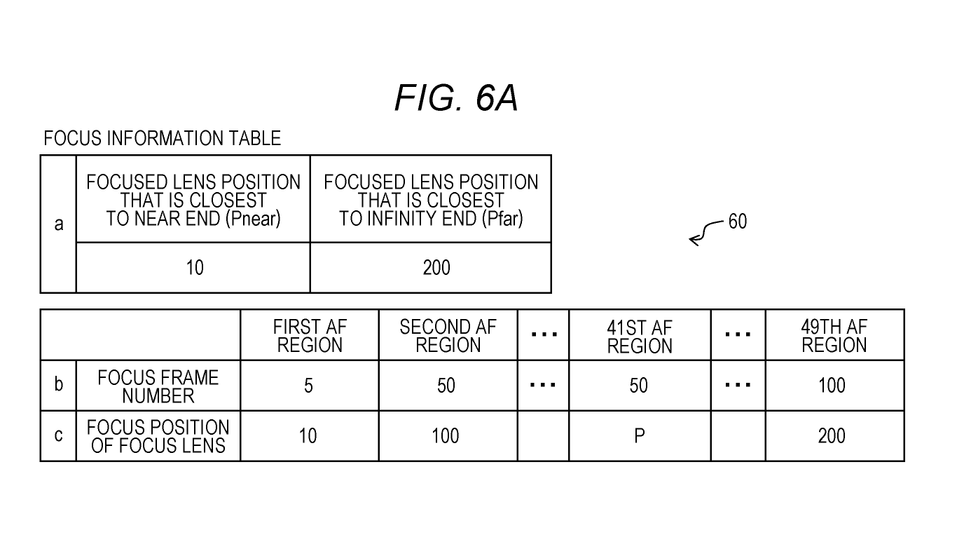

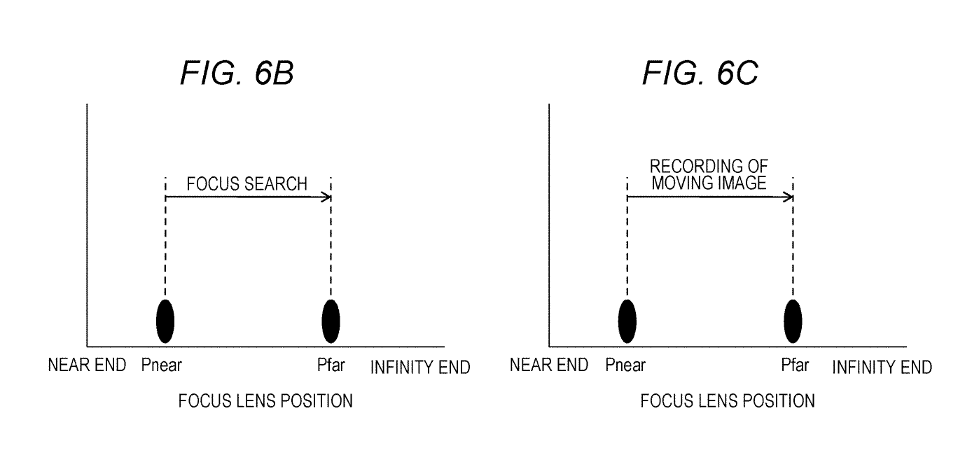

FIG. 6A is a diagram illustrating an example of focus information table 60 in digital camera 100 according to the first exemplary embodiment. Focus information table 60 includes information representing a drive range of focus lens 111 in the focus search operation and the moving image recording operation. Concretely, focus information table 60 stores information representing a focus lens position (Pnear) that is closest to the nearest end (a nearest focus lens position) and information representing a focus lens position (Pfar) that is closest to the infinity end (a farthest focus lens position) as information representing the drive range of the focus lens (see a in FIG. 6A). The drive range of focus lens 111 is set by the user (details are described later). Further, focus information table 60 relates a focus position with respect to each AF region (a position of focus lens 111 during the focus on each AF region, see b in FIG. 6A) with a frame number of a frame in a focused state on each AF region (see c in FIG. 6A) so as to manage the positions and the frame numbers.

For example, in the focus search operation, a contrast value is obtained for each AF region while focus lens 111 is being moved. At this time, for example, on AF region 41 shown in FIG. 5A, as shown in FIG. 5B, when a peak of the contrast value is detected in focus lens position P, focus lens position P is recorded in the focus information table (see c in FIG. 6A). Thereafter, in the moving image recording operation, the frame number of the frame photographed in focus lens position P (in this example, 50) is related to the position of focus lens 111 (in this example, P), so that the frame number and the position are recorded in focus information table 60 (b in FIG. 6A). Focus information table 60 is stored, for example, in a header portion of moving image data obtained by taking a moving image.

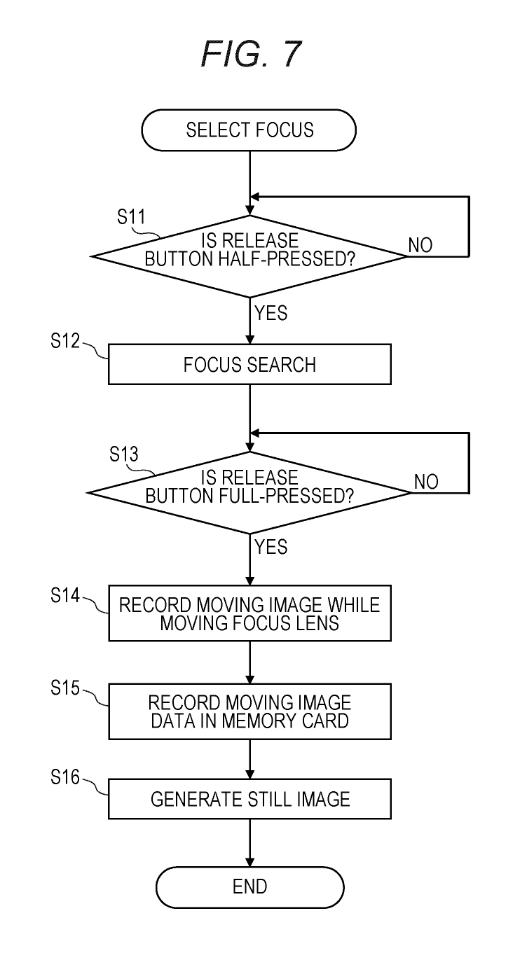

The focus selecting operation of digital camera 100 is described with reference to the flowchart in FIG. 7. FIG. 7 is a flowchart illustrating the focus selecting operation in digital camera 100 according to the first exemplary embodiment.

In digital camera 100, when the user half-presses release button 211 in a state that the focus selecting function is set to be activated in advance (YES at step S11), controller 180 detects the focus position for each AF region of an image so as to perform a focus search to complete focus information table 60 (step S12).

In the focus search, controller 180 moves focus lens 111 from the near end to the infinity end (or vice versa) in a predetermined drive range of the focus lens, and simultaneously detects the contrast value on each AF region (see FIG. 5A, FIG. 5B). The predetermined drive range of focus lens 111 is set based on an operation performed by the user in advance before the focus search, and is recorded as the nearest focus lens position (Pnear) and the farthest focus lens position (Pfar) into focus information table 60. Controller 180 can recognize the predetermined drive rage by seeing focus information table 60. FIG. 6B is a diagram for describing a drive range of the focus lens during the focus search in the digital camera according to the first exemplary embodiment. That is to say, in the focus search, focus lens 111 moves, as shown in FIG. 6B, between the nearest focus lens position (Pnear) and the farthest focus lens position (Pfar). In the focus search, the drive range of focus lens 111 is limited to the predetermined drive range, so that a time required for the focus search can be made shorter than a case where the drive range of focus lens 111 is an entire range.

When focus lens 111 is moved from the nearest end to the infinity end within the predetermined drive range of the focus lens, controller 180 records a position of focus lens 111 where the contrast value is the largest in a plurality of images (see FIG. 5B) on each AF region into focus information table 60 (see c in FIG. 6A). When the contrast value of any image is smaller than a predetermined threshold on one region, the focus position is not defined on this region. A predetermined value representing that the focus position is unclear is recorded into focus information table 60. Then, the focus search is completed. In this state, focus information table 60 does not yet include information about frame numbers.

When the user full-presses release button 211 (YES at step S13), an image photographing operation is started.

FIG. 6C is a diagram for describing the drive range of focus lens 111 during recording of a moving image in digital camera 100 according to the first exemplary embodiment. Controller 180, as shown in FIG. 6C, returns focus lens 111 to nearest focus lens position Pnear. Then, while moving focus lens 111 to farthest focus lens position Pfar, controller 180 records a moving image (step S14). The drive range of focus lens 111 is limited to the predetermined range, so that a time required for recording a moving image can be made shorter than the case where the drive range of focus lens 111 is the entire range. A moving image is recorded according to a predetermined format for moving image data. For example, a moving image is recorded according to the MP4 standard (H.264/MPEG-4 AVC (Moving Picture Experts Group-4 Advanced Video Coding) method). During recording of a moving image, for example, an icon or a message representing that a moving image is being recorded may be displayed on display monitor 220.

Controller 180 relates the position of focus lens 111 on each AF range with the frame number of each frame configuring the moving image during recording of the moving image. That is to say, a number of a frame photographed in a focus lens position represented by the focus position of the focus lens (see c in FIG. 6A) in focus information table 60 is obtained on each AF region, and the number is related to the focus position of the focus lens so as to be recorded in focus information table 60 (see b in FIG. 6A). As a result, in focus information table 60, each frame number is related to each AF region (see b in FIG. 6A).

When the recording of the moving image is completed, moving image data whose header is provided with focus information table 60 is recorded in memory card 200 (step S15). As a result, the image photographing operation is completed.

After the completion of the image photographing operation, a process for generating a still image is executed according to an instruction from the user (step S16). Concretely, a still image, which is focused on a subject specified by the user or on a region of the image, is generated (cut out) from the moving image recorded in the image photographing operation. Details of this still image generating operation are described below.

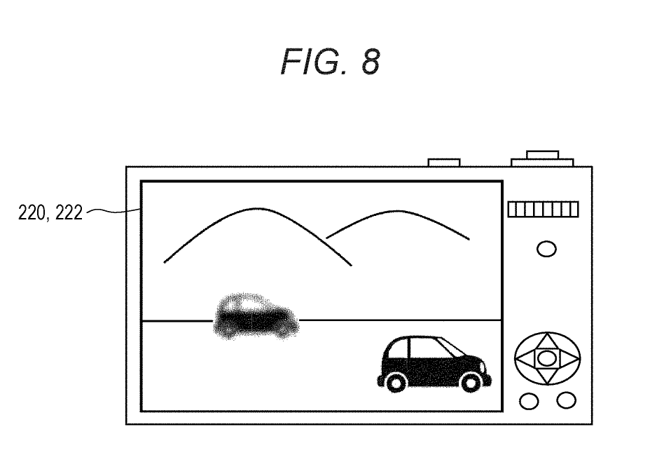

FIG. 8 is a diagram illustrating an example of a screen to be displayed just after the completion of the recording of moving image data (a focus region specifying screen) in digital camera 100 according to the first exemplary embodiment. After the completion of the image photographing operation, as shown in FIG. 8, controller 180 displays one frame image in a plurality of frame images configuring the recorded moving image on display monitor 220. At this time, for example, in the plurality of frame images configuring the recorded moving image, a frame image (a still image) recorded first or last is displayed.

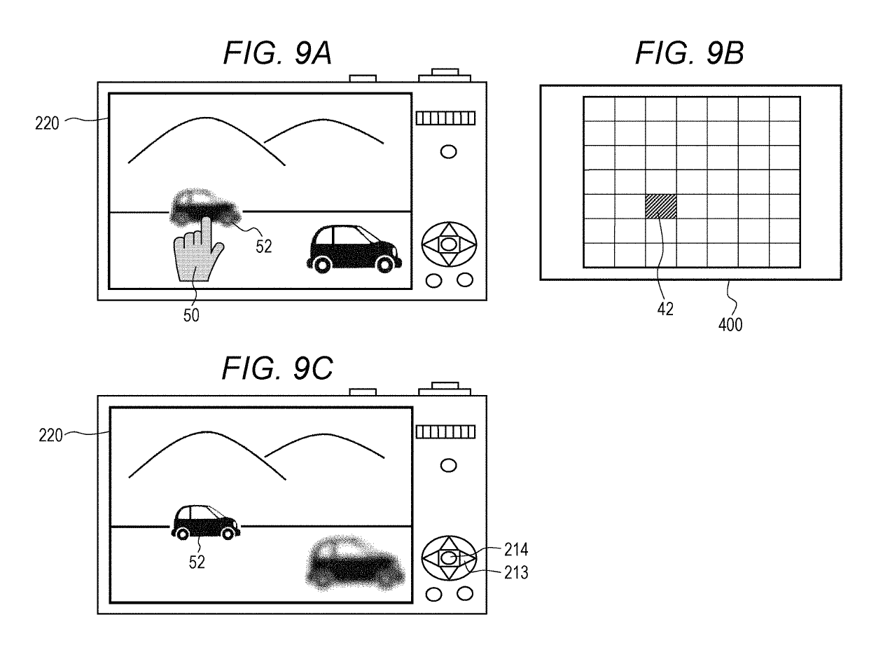

The user operates touch panel 222 provided to a rear surface of the camera to specify a subject (namely, a region) to be focused on the displayed image. FIG. 9A is a diagram for describing an operation for specifying a focus region desired by a user in digital camera 100 according to the first exemplary embodiment. For example, as shown in FIG. 9A, user 50 touches a region of subject 52 to specify subject 52 as a target (region) to be focused.

When the user specifies the region of the subject, controller 180 specifies an AF region related to the subject region specified by the user, and specifies a focused frame relating to the specified AF region with reference to focus information table 60. FIG. 9B is a diagram for describing the focus region specified by the user in digital camera 100 according to the first exemplary embodiment. For example, as shown in FIG. 9A, when subject 52 is specified by the user, as shown in FIG. 9B, controller 180 specifies AF region 42 related to subject 52. Controller 180 specifies a frame number of a focused frame relating to AF region 42 with reference to focus information table 60.

Controller 180 displays a frame image of the specified frame number on display monitor 220. For example, in an image shown in FIG. 9A, when subject 52 is specified by user 50, as shown in FIG. 9C, an image focused on specified subject 52 (or AF region 42) is displayed. FIG. 9C is a diagram for describing an image focused on subject 52 specified by the user (or AF region 42) in the digital camera according to the first exemplary embodiment.

When the image displayed on display monitor 220 is a desired image, the user presses decision button 214 to be capable of specifying the image as a still image to be recorded. On the other hand, when the image displayed on display monitor 220 is not a desired image, the user operates selection button 213 or a focus ring to be capable of switching an image to be displayed on display monitor 220.

When the user presses decision button 214, the displayed image (the frame image) is cut out as a still image to be recorded in memory card 200. Instead of memory card 200 or in addition to memory card 200, still image data may be recorded in built-in memory 240 or another recording medium.

The moving image data is recorded according to moving image codec (H.264, H.265, etc.), and inter-frame compression is carried out. For this reason, when a frame of the moving image data is cut out as a still image, controller 180 converts data of a frame image into a format of a still image (for example, JPEG (Joint Photographic Experts Group)) so as to record the converted data.

The focus selecting function enables the user to obtain a still image focused on a desired subject or region after the image is photographed. In other words, the user can select the focus position after the photography.

### 2.2 Setting of Drive Range of Focus Lens

In digital camera 100 according to this exemplary embodiment, the user can set the drive range of focus lens 111 during the focus search and the recording of a moving image in the focus selecting operation. The setting of the drive range of focus lens 111 to be performed by the user during the focus search and the recording of a moving image is described below.

In digital camera 100 according to this exemplary embodiment, the drive range of focus lens 111 during the focus search and the recording of the moving image is set based on an operation for touching two points on touch panel 222 performed by the user.

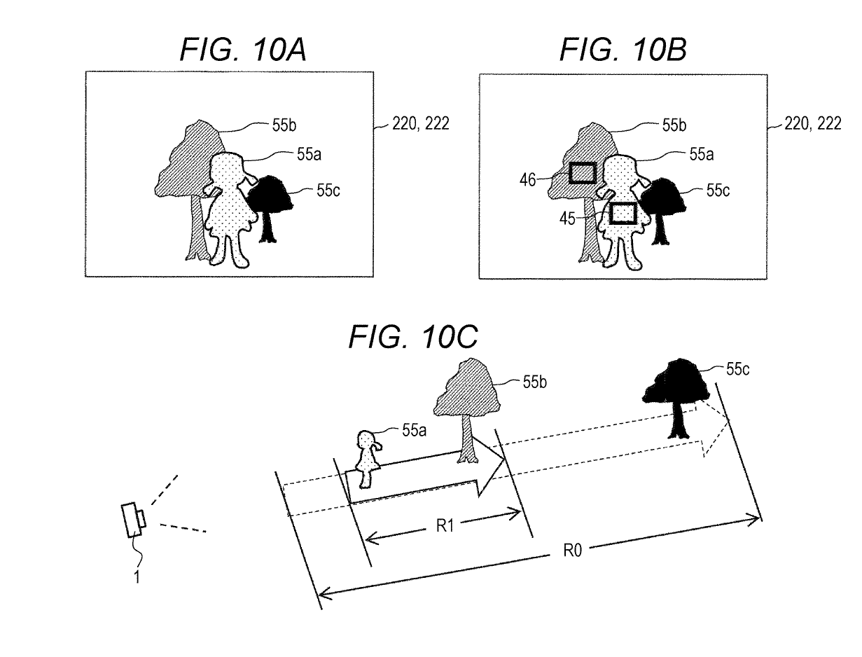

FIG. 10A is a diagram for describing setting of the drive range of the focus lens based on the touch operation performed by the user in the digital camera according to the first exemplary embodiment. For example, when the user specifies subject 55a and subject 55b through the touch operation in a state that three subjects 55a, 55b, 55c shown in FIG. 10A are within an angular field of digital camera 100, the drive range of focus lens 111 is set so as to be focused on a subject in a range between subject 55a and subject 55b.

FIG. 10B is a diagram for describing a partial region of the subject in FIG. 10A. FIG. 10C is a diagram for describing drive range R1 of focus lens 111 in the digital camera according to the first exemplary embodiment. That is to say, when the user touches partial region 45 of subject 55a and partial region 46 of subject 55b as shown in FIG. 10B, the drive range R1 of focus lens 111 is set so that focus can be achieved in a range between a position of the focus lens where the contract value becomes a peak in region 45 and a position of the focus lens where the contrast value becomes a peak in region 46 as shown in FIG. 10C. In this case, the drive range of focus lens 111 can be limited to range R1 shorter than whole drive range R0 of focus lens 111. Therefore, the time required for the process during the focus search and the recording of a moving image can be shortened. Further, the user can specify a photograph range during the photograph of an image through a simple touch operation. Therefore, usability is improved.

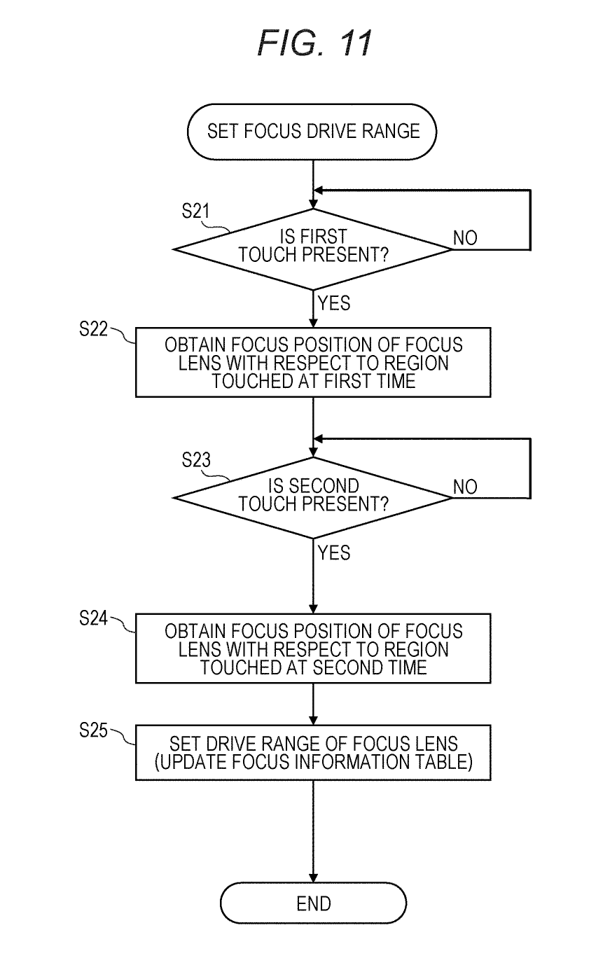

FIG. 11 is a flowchart illustrating the process for setting the drive range of focus lens 111 in the digital camera according to the first exemplary embodiment. The process for setting the drive range of focus lens 111 is performed when the focus selecting function is set to ON.

Controller 180 determines whether the user performs the touch operation based on a detection signal from touch panel 222 (step S21). When controller 180 detects the touch operation (YES at step S21), controller 180 performs an autofocus operation on a region of a photographed image related to the touched region on touch panel 222 to decide a focus position of focus lens 111 (step S22). At this time, the obtained focus position is stored in built-in memory 240.

Controller 180 determines whether the user performs a next touch operation based on a detection signal from touch panel 222 (step S23). When controller 180 detects a second touch operation (YES at step S23), controller 180 obtains the focus position of focus lens 111 with respect to the region of the photographed image related to the secondly touched region (step S24). At this time, the obtained focus position of focus lens 111 is stored in built-in memory 240.

Controller 180 sets the drive range of focus lens 111 using the focus positions of focus lens 111 obtained during the detection of the first and second touch operations (step S25). Concretely, controller 180 sets the focus position closer to the near end in the focus positions of focus lens 111 obtained by the first and second touch operations as the nearest focus lens position (Pnear), and sets the focus position closer to the infinity end as the farthest focus lens position (Pfar) so as to update focus information table 60.

The nearest focus lens position (Pnear) and the farthest focus lens position (Pfar) are updated in focus information table 60 based on the touch operation performed by the user. As a result, the drive range of focus lens 111 during the focus search and the recording of a moving image is set.

### 3. Advantageous Effects and the Like

The imaging device corresponding to digital camera 100 according to this exemplary embodiment includes optical system 110 having focus lens 111, the imaging unit corresponding to CCD 140 that images a subject image input via optical system 110 and generates an image signal, image processor 160 that executes a predetermined process on the image signal and generates image data, the operation unit corresponding to touch panel 222 that accepts a user operation, and the controller corresponding to controller 180 that controls image processor 160. The controller executes a search process for obtaining a focus distance in each of a plurality of predetermined regions of the image indicated by the image data while moving focus lens 111 in a predetermined drive range. After the search process, the controller records a moving image while moving focus lens 111, and extracts a frame image focused on a region specified by a user via the operation unit as the still image from a plurality of frame images forming the recorded moving image data. Before the search process, the controller sets the predetermined drive range based on the range specified by the user via the operation unit.

The operation unit may be a touch panel that accepts a touch operation from a user while a region on a displayed image is regarded as an input region. Further, the controller may set the predetermined drive range based on two points specified on the touch panel by the user.

In digital camera 100 according to this exemplary embodiment (one example of the imaging device), the drive range of focus lens 111 during the focus search and the recording of a moving image is set based on the user operation on touch panel 222 (one example of the operation unit). As a result, the drive of focus lens 111 in the entire range can be reduced, so that the processing time for the focus search process or the like can be shortened. Further, since the user operation enables the range to be specified, the simple operation enables the setting of the focus drive range. Therefore, usability of the user is improved.

The controller may record a moving image while moving the focus lens in the predetermined drive range.

Further, in the search process, the controller generates a table where each of the plurality of predetermined regions and information are managed in association with each other, the information representing any of the plurality of frame images focused on the predetermined region, and extracts a still image with reference to the table.

The image device may further include release button 211 with which the user instructs start of the photographing operation. When the release button is half-pressed, the controller may start the search process. When the release button is full-pressed, the controller may start the process for recording a moving image.

### Second Exemplary Embodiment

Another example of the process for setting a drive range of focus lens 111 is described below. In the first exemplary embodiment, focus position of focus lens 111 is obtained by each touch operation, but in this exemplary embodiment, the focus position of focus lens 111 is not obtained by each touch operation.

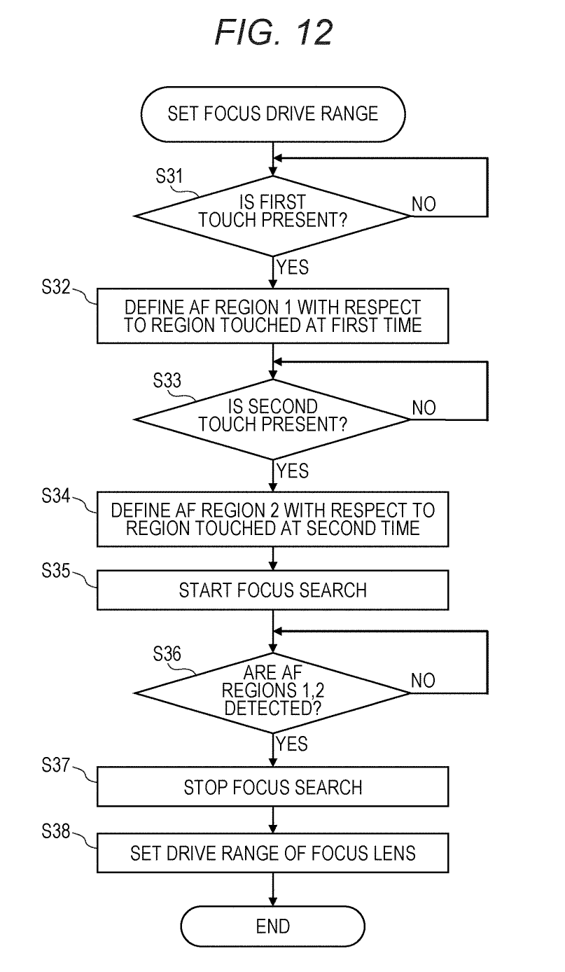

FIG. 12 is a flowchart illustrating the process for setting the drive range of focus lens 111 in digital camera 100 according to a second exemplary embodiment. This process is executed when a focus selecting function is set to ON.

Controller 180 determines whether the user performs the touch operation based on a detection signal from touch panel 222 (step S31). When controller 180 detects a touch operation (YES at step S31), controller 180 defines an AF region (AF region 1) related to a touched region on touch panel 222 (step S32).

Controller 180 determines whether the user performs a next touch operation based on a detection signal from touch panel 222 (step S33). When controller 180 detects a second touch operation, controller 180 defines an AF region (AF region 2) related to a second touched region (step S34). In this exemplary embodiment, differently from the first exemplary embodiment, a focus position is not obtained at a stage of touch.

Controller 180 starts focus search (step S35). Controller 180 performs the focus search until AF region 1 and AF region 2 are detected as focus regions of an image. The focus search as described in the flowchart of FIG. 7 may be started by half-pressing release button 211 by the user.

When AF region 1 and AF region 2 are detected as the focus regions (YES at step S36), controller 180 stops the focus search (step S37), and sets the drive range of focus lens 111 using the focus positions on AF region 1 and AF region 2 (step S38). Concretely, controller 180 sets the focus position closer to a near end in the focus positions of focus lens 111 obtained for AF region 1 and AF region 2 as the nearest focus lens position (Pnear), and sets the focus position closer to an infinity end as the farthest focus lens position (Pfar) so as to update focus information table 60.

With the above method, the nearest focus lens position (Pnear) and the farthest focus lens position (Pfar) can be set in focus information table 60. As a result, a processing time required for the focus search operation can be shortened.

### Another Exemplary Embodiment

The first and second exemplary embodiments have been described as examples of the techniques disclosed in the present disclosure. However, the techniques in the present disclosure are not limited to these exemplary embodiments, and thus can be applied also to an exemplary embodiment where modification, replacement, addition and omission are suitably made. Further, the components described in the first and second exemplary embodiments can be combined so as to carry out a new exemplary embodiment. Another exemplary embodiment is illustrated below.

(1) The method for setting the drive range of the focus lens described in the above exemplary embodiments can be applied also to a case where a function other than the focus selecting function is realized. That is to say, the method for setting the drive range of the focus lens as described above can be applied to the setting of the drive range of the focus lens when a moving image or continuous still images are recorded while the focus lens is being moved. For example, in a depth synthesis (focal point synthesis) function, a range of an image to be used for synthesis (a range of a subject to be focused) may be set by specification through a touch panel operation. The depth synthesis (focal point synthesis) process is a process for synthesizing images recorded on a plurality of focus positions and generating a still image having a pseudo-deep subject depth.

In the above exemplary embodiments, the focus drive range is specified based on two touch operations. The operation for specifying the focus drive range is not limited to the touch operation. Any operation can be used as long as a start point and an end point of the focus drive range can be specified. For example, the start point of the focus drive range (or the end point) is touched, a finger is moved while touching the panel, and then the finger is removed from the touch panel at the end point (or the start point) of the focus drive range, so that the focus drive range may be specified.

Further, the setting of the focus drive range during two touch operations has been described in the above exemplary embodiments, but the number of performing times of the touch operation is not limited to two. When a third touch operation is performed, the second touch operation may be inactivated and the third touch operation may be activated. In another manner, in the two focus positions (Pnear, Pfar) that have been already registered in the focus information table, the position closer to a focus position obtained by the third touch operation may be replaced by the focus position obtained by the third touch operation. The same can be applied to fourth or thereafter touch operations.

(2) In the above exemplary embodiments, focus information table 60 stores the focus position (Pnear) that is the closest to the near end and the focus position (Pfar) that is the closest to the infinity end. However, these focus positions (Pnear, Pfar) are not necessarily stored in focus information table 60, and may be saved independently from focus information table 60.

(3) In the above exemplary embodiments, focus information table 60 stores, for each AF region, information (frame number) indicating the frame focused on each AF region (focused frame). However, the configuration of focus information table 60 is not limited to this. The focus information table may store, for each AF region, the position of focus lens 111 that is put in focus on each AF region. In this case, a second table indicating a relationship between a focus lens position and each frame may be created during recording of a moving image. When a still image is cut out, a frame image to be cut out from a moving image can be specified with reference to the focus information table and the second table.

(4) In the above exemplary embodiments, an imaging device is configured by CCD, but the imaging device is not limited to this. The imaging device may be configured by an NMOS (n-Channel Metal-Oxide Semiconductor) image sensor or a CMOS (Complementary Metal-Oxide Semiconductor) image sensor.

(5) The focus selecting function disclosed in the above exemplary embodiments can be applied to both digital cameras which are interchangeable lens cameras and all-in-one cameras.

(6) In the above exemplary embodiments, a digital camera is described as one example of the imaging device, but the imaging device is not limited to this. An idea of the present disclosure can be applied to various imaging devices such as a digital video camera, a smartphone, and a wearable camera that can take moving images.

The exemplary embodiments have been described above as the examples of the techniques disclosed in the present disclosure. Therefore, the accompanying drawings and the detailed description have been provided. Thus, the components described in the accompanying drawings and the detailed description may include not only the components essential for solving the problem but also components that are not essential for solving the problem in order to illustrate the above techniques. For this reason, even if these unessential components are described in the accompanying drawings and the detailed description, these unessential components should not be immediately approved as being essential. Further, since the above embodiments illustrate the techniques of the present disclosure, various modifications, replacements, additions and omissions can be made within the scope of claims and an equivalent scope.

The present disclosure is applicable to the imaging device that can take moving images. Concretely, the present disclosure is applicable to various imaging devices such as a digital video camera, a smartphone, and a wearable camera that can take moving images.

What is claimed is:

1. An imaging device comprising:
an optical system including a focus lens;
an imaging unit that images a subject image input via the optical system and generates an image signal;
an image processor that executes a predetermined process on the image signal and generates image data;
an operation unit that accepts a user operation; and
a controller that controls the image processor,
wherein the controller
executes a search process for obtaining a focus distance in each of a plurality of predetermined regions of an image indicated by the image data while moving the focus lens in a predetermined drive range,
after the search process, records a moving image while moving the focus lens,
extracts, as a still image, a frame image focused on a region specified by a user via the operation unit from a plurality of frame images forming recorded moving image data, and
before the search process, sets the predetermined drive range based on a range specified by the user via the operation unit.

2. The imaging device according to claim 1, wherein
the operation unit is a touch panel that accepts a touch operation from the user while regarding a region on a displayed image as an input region, and
the controller sets the predetermined drive range based on two points specified on the touch panel by the user.

3. The imaging device according to claim 1, wherein the controller records the moving image while moving the focus lens in the predetermined drive range.

4. The imaging device according to claim 1, wherein
the controller
in the search process, generates a table where each of the plurality of predetermined regions and information are managed in association with each other, the information representing any of the plurality of frame images focused on the predetermined region, and
extracts the still image with reference to the table.

5. The imaging device according to claim 1, further comprising
a release button with which the user instructs start of photographing operation,
wherein, when the release button is half-pressed, the controller starts the search process, and when the release button is full-pressed, the controller starts a process for recording the moving image.
